(19) United States
(12) Patent Application Publication
(10) Pub. No.: US 2021/0082382 A1
(43) Pub. Date: Mar. 18, 2021

(54) Method and System for Pairing Visual Content with Audio Content

(71) Applicant: Love Turntable, Inc., Los Angeles, CA (US)

(72) Inventor: Charles-Henri Andre Pinhas, Los Angeles, CA (US)

(21) Appl. No.: 17/017,922

(22) Filed: Sep. 11, 2020

Related U.S. Application Data
(63) Continuation of application No. PCT/US2020/050201, filed on Sep. 10, 2020.
(60) Provisional application No. 62/899,385, filed on Sep. 12, 2019.

(51) Int. Cl. G10H 1/36; G06F 16/903; G06F 16/632; G06F 16/683; G06F 16/9536; G06F 16/9038

(52) U.S. Cl. CPC G10H 1/368; G06F 16/90335; G06F 16/9038; G06F 16/685; G06F 16/9536; G06F 16/634

(57) ABSTRACT

Methods and systems are disclosed herein that provide an automatic song visualization and discovery service with automatic search for content to be paired and/or synchronized with playing of the song. In an example embodiment, while audio content such as a song plays (through user device or other player), the matching service can automatically identify information about the song (e.g., identifying the song by title and artist), transfer the song identification data to a content matching database, and then automatically return to the user a relevant item of additional content for pairing and/or synchronization with the song. As examples, such additional content could take the form of a video, an image (e.g., an album art cover), standard or karaoke-style lyrics, DJ-like lighting, a hologram, and the like (or any combination thereof).

CROSS-REFERENCE AND PRIORITY CLAIM TO RELATED PATENT APPLICATIONS

This patent application claims priority to U.S. provisional patent application 62/899,385, filed Sep. 12, 2019, and entitled “Method and System for Pairing Visual Content with Audio Content”, the entire disclosure of which is incorporated herein by reference.

This patent application is also a continuation of PCT patent application PCT/US2020/050201, filed Sep. 10, 2020, and entitled “Method and System for Pairing Visual Content with Audio Content”, the entire disclosure of which is incorporated herein by reference.

### INTRODUCTION

Conventional audio/video (AV) systems suffer from shortcomings with respect to the pairing of audio content with visual content. For example, with conventional AV systems, users are typically limited to pairings that have been decided a priori by content providers. That is, for example, a content provider will decide in advance that a particular video should accompany a song; or the content provider will identify in advance an album cover that is to be displayed on a device when a song is played. These conventional approaches to pairing visual content with audio content are limited with respect to flexibility for pairing visual content with audio content in a manner beyond that planned in advance by content providers. Accordingly, it is believed that there is a technical need in the art for improved AV systems that are capable of interacting with one or more databases where visual content can be searched and retrieved to pair such visual content with audio content using automated techniques.

Toward this end, innovative technology is disclosed herein for methods and systems that provide an automatic song visualization and discovery service with automatic search for content to be paired and/or synchronized with playing of the song. Examples of content to be paired and/or synchronized with the playing of the song may include videos, images, holograms, and lighting.

In an example embodiment, while audio content such as a song plays (through user device or other player), the matching service (which can be referred to as “Song Illustrated”, “Music Genie”, and/or “Music Seen” for ease of reference with respect to an example) automatically identifies information about the song (e.g., identifying the song by title and artist), transfers the song identification data to a content matching database, and then automatically returns to the user a relevant item of additional content for pairing and/or synchronization with the song. As examples, such additional content could take the form of a video, an album art cover, standard or karaoke-style lyrics, DJ-like lighting, a hologram, and the like (or any combination thereof). As examples the content matching database can be any of a number of different types of existing services that can serve as accessible repositories of visual content. Examples include streaming video serves (e.g., YouTube, etc.) and/or social media services (e.g., Instagram, TikTok, Facebook, etc.). In this fashion, embodiments described herein are able to use automated techniques that operate to convert such third party services into automatic and music-relevant visualizers.

These and other features and advantages of the invention will be described hereinafter with respect to various example embodiments.

### BRIEF DESCRIPTION OF THE DRAWINGS

FIG. 1 shows an example process flow for pairing visual content with audio content for concurrent presentation of the audio and visual content to a user via one or more devices.

FIG. 2A shows an example process flow for steps 108 and 110 of FIG. 1.

FIG. 2B shows another example process flow for steps 108 and 110 of FIG. 1.

FIG. 3 shows an example user interface that can be employed to present a user with alternative pairing options.

FIG. 4 shows an example process flow where the application logs and processes user feedback about pairings between selected visual content and audio content.

FIG. 5 shows an example of a first AV system embodiment that can employ inventive techniques described herein.

FIG. 6 shows an example of a second AV system embodiment that can employ inventive techniques described herein.

FIG. 7 shows an example of a third AV system embodiment that can employ inventive techniques described herein.

FIG. 8 shows an example of a fourth AV system embodiment that can employ inventive techniques described herein.

FIG. 9 shows an example of a fifth AV system embodiment that can employ inventive techniques described herein.

FIG. 10 shows an example of a sixth AV system embodiment that can employ inventive techniques described herein.

FIG. 11 shows an example of a seventh AV system embodiment that can employ inventive techniques described herein.

FIG. 12 shows an example of an eighth AV system embodiment that can employ inventive techniques described herein.

FIG. 13 shows an overview of an example AV system and depicts how an application can operate to pair visual content with audio content for presentation to users

FIG. 14 is a sketch that illustrates an example user experience with respect to an example embodiment.

FIG. 15 is a sketch that illustrates an example process for logging in with respect to an example embodiment.

FIG. 16 is a sketch that illustrates an example software syncing process with respect to an example embodiment.

FIG. 17 is a sketch that illustrates an example music syncing process with respect to an example embodiment.

FIG. 18 is a sketch that illustrates an example of visuals that can be displayed during buffering time by the system.

FIG. 19 is a sketch that illustrates an example search method with visual content priorities with respect to an example embodiment.

### DETAILED DESCRIPTION OF EXAMPLE EMBODIMENTS

Portions of the specification to follow will organize a discussion of example embodiments in the following sections.
1. TECHNICAL DESCRIPTION
2. USER EXPERIENCE AND EXAMPLE FEATURES
3. EXAMPLE LOGIN PROCESS
4. EXAMPLE VISUALS FOR USE DURING BUFFERING TIME
5. OTHER EXAMPLE FEATURES AND HARDWARE

### 1. Technical Description

For purposes of discussion with respect example embodiments, we will use the term “app” or “application” to refer to the software program(s) that can be used to process data in any of a number of ways to perform the operations discussed herein. It should be understood that such an app can be embodied by non-transitory, processor-executable instructions that can be resident on a computer-readable storage medium such as computer memory. It should be understood that the app may take the form of multiple applications that are executed by different processors that may be distributed across different devices within a networked system if desired by a practitioner.

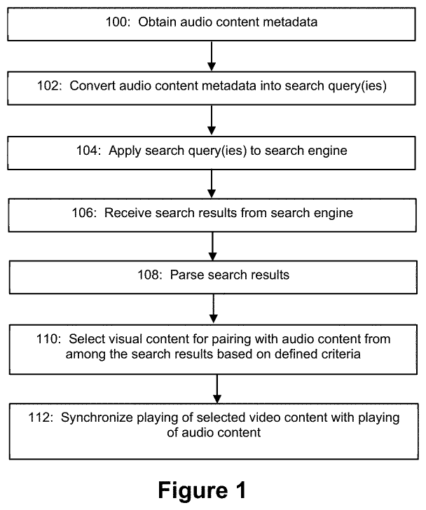

FIG. 1 shows an example process flow for execution by one or more processors as part of an audio/visual (AV) system that is configured to pair visual content with audio content for concurrent presentation of the audio and visual content to the user via one or more devices, such as smart phones, tablet computers, speakers, turntables, and/or television screens. An example of audio content that can be used with the AV system is a song. Examples of visual content to be paired and/or synchronized with the playing of the song may include videos, images, holograms, and lighting. These forms of visual content can serve as purely artistic items that are aimed for enhancing the enjoyment of users who listen to the song. However, such visual content may also take the form of advertisements that are selected according to an advertising model that targets the advertisements toward users in order to generate revenue and defray operating costs for the system. Such advertisements can be interleaved with other types of visual content and/or superimposed over a portion of the display area for concurrent presentation along with other types of visual content. Further still, it should be understood that the visual content itself, even if not an advertisement itself (per se) could be selected for presentation to users based at least in part according to pay models that can generate revenue for operators of the system and/or providers of the visual content.

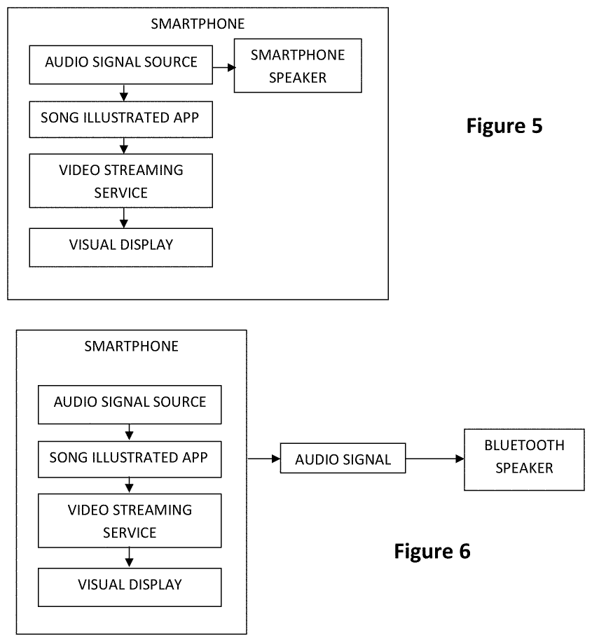

FIGS. 5-12 show examples of different AV system topology embodiments in which such devices can be employed as part of the AV system. The devices that are part of the AV systems can include one or more processors that execute the application.

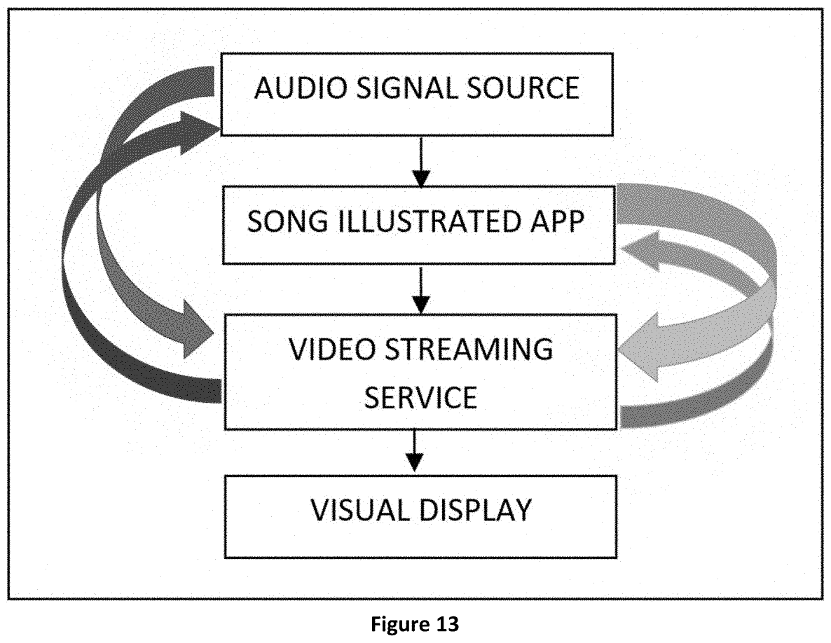

FIG. 13 shows a high level overview of an example AV system and depicts how an application can operate to pair visual content with audio content for presentation to users. The system of FIG. 13 employs an audio signal source, the app, a video streaming service, and a visual display. FIG. 1 (discussed below) describes an example of how these system components can interact to improve how visual content is paired with audio content for presentation to users.

With the example of FIG. 5, the AV system takes the form of a mobile device such as a smart phone. In the example of FIG. 5, a song is played via a speaker resident on the smart phone. The system components shown by FIG. 13 are also resident on the smart phone. Accordingly, the audio signal source can take the form of memory resident on the smart phone (where the memory either stores the song locally or provides a pathway for streaming the song through the smart phone via a network source). The Song Illustrated app (which could also be referred to as the “Music Genie” and/or “Music Seen” app as noted above) can take the form of a mobile app that has been downloaded onto the smart phone for execution by a processor resident on the smart phone. The video streaming service can be a mobile application or native capability of the smart phone to stream video content. The visual display can be a screen of the smart phone. Together, the video streaming service, visual display, and smart phone speaker can serve as the “player” for the visual and audio content with respect to the example of FIG. 5. Also, while the example of FIG. 5 shows a smart phone as the device for the AV system, it should be understood that other mobile devices could be used, such as tablet computers (e.g., an iPad or the like). Similarly, a laptop computer or smart TV could be used in place of the smart phone.

With the example of FIG. 6, the AV system takes the form of a mobile device such as a smart phone in combination with an external speaker such as a Bluetooth speaker. In the example of FIG. 6, a song is played via the external speaker that has been paired or connected with the mobile device. For example, the smart phone can transmit an audio signal representative of the song to the Bluetooth speaker, whereupon the Bluetooth speaker produces the sound output corresponding to that audio signal. Meanwhile, the visual content can be presented to the use via the video streaming service and the visual display. Together, the video streaming service, visual display, and Bluetooth speaker can serve as the “player” for the visual and audio content with respect to the example of FIG. 6. Also, while the example of FIG. 6 shows a smart phone as a device for the AV system, it should be understood that other mobile devices could be used, such as tablet computers (e.g., an iPad or the like). Similarly, a laptop computer or smart TV could be used in place of the smart phone.

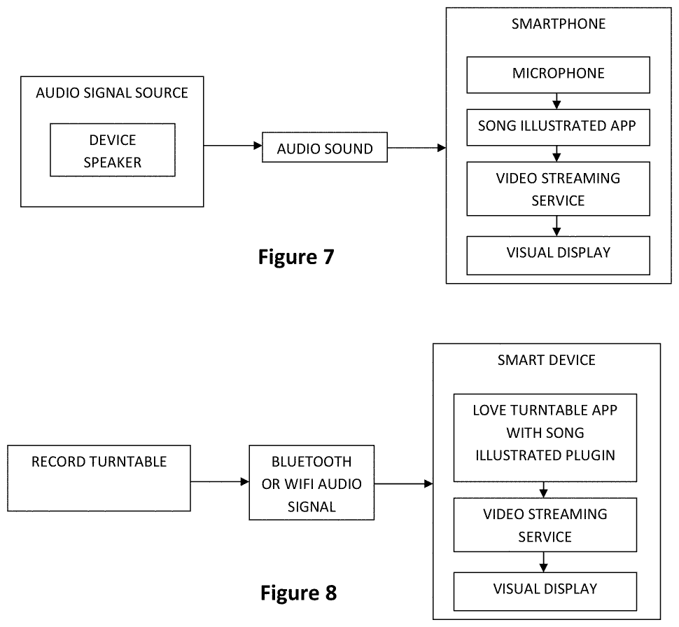

With the example of FIG. 7, the AV system takes the form of an external source for the audio signal (such as an external speaker) in combination with a device such as a smart phone (or tablet computer, laptop computer, smart TV, etc.). In the example of FIG. 7, a song is played via the external speaker. A microphone resident on the device then picks up the audio sound produced by the speaker. As discussed below, an app executed by the device can determine the song played by the speaker using waveform recognition techniques. Based on the song detection, the app can interact with the video streaming service and visual display that are resident on the device to present visual content that has been paired with the detected audio content. Together, the audio signal source, video streaming service, and visual display can serve as the “player” for the visual and audio content with respect to the example of FIG. 7.

With the example of FIG. 8, the AV system takes the form of a record turntable in combination with a device such as a smart phone (or tablet computer, laptop computer, smart TV, etc.). An example of a record turntable that can be used in this regard is the LOVE turntable available from Love Turntable, Inc. (see U.S. Pat. Nos. 9,583,122 and 9,672,844, the entire disclosures of each of which are incorporated herein by reference). In the example of FIG. 8, a song is played via the record turntable, and while the song is played, the record turntable outputs an audio signal (e.g., a Bluetooth audio signal or a WiFi audio signal) that represents the song being played by the record turntable. An app executed by the device receives this audio signal and determines the song that is being played. Based on the song detection, the app can interact with the video streaming service and visual display that are resident on the device to present visual content that has been paired with the song being played by the record turntable. Together, the record turntable, video streaming service, and visual display can serve as the “player” for the visual and audio content with respect to the example of FIG. 8.

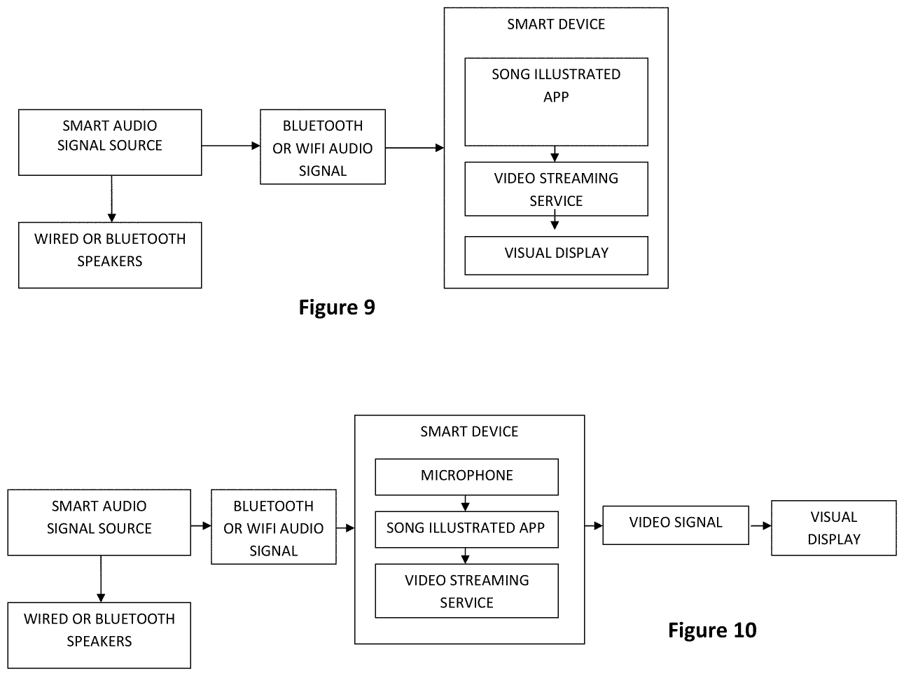

With the example of FIG. 9, the AV system takes the form of an external smart audio signal source and speakers in combination with a device such as a smart phone (or tablet computer, laptop computer, smart TV, etc.). The smart audio signal source can be a song source such as Spotify, Apple Music, Pandora, etc. In the example of FIG. 9, speakers (which may be wired or wireless (e.g., Bluetooth) speakers) play the song provided by the smart audio signal source. While the song is playing, the smart audio signal source also outputs an audio signal (e.g., a Bluetooth audio signal or a WiFi audio signal) that represents the song being played via the speakers. Similar to the FIG. 8 embodiment, an app executed by the device receives this audio signal and determines the song that is being played. Based on the song detection, the app can interact with the video streaming service and visual display that are resident on the device to present visual content that has been paired with the song being played by the record turntable. Together, the speakers, video streaming service, and visual display can serve as the “player” for the visual and audio content with respect to the example of FIG. 9.

With the example of FIG. 10, the AV system takes the form of an external smart audio signal source and speakers in combination with a device such as a smart phone (or tablet computer, laptop computer, etc.) and an external visual display (such as a computer monitor, smart TV, video projector, hologram projector, etc.). In the example of FIG. 10, the speakers (which may be wired or wireless (e.g., Bluetooth) speakers) play the song provided by the smart audio signal source. While the song is playing, the smart audio signal source also outputs an audio signal (e.g., a Bluetooth audio signal or a WiFi audio signal) that represents the song being played via the speakers. Similar to the FIG. 8 embodiment, an app executed by the device receives this audio signal and determines the song that is being played. Based on the song detection, the app can interact with the video streaming service to obtain the visual content to be paired with the song. With the FIG. 8 embodiment, this visual content is presented to the user via an external visual display. Accordingly, the device transmits a video signal that represents the paired visual content, and this video signal is received by the external visual display. Upon receipt of the video signal, the external video display renders the visual content for presentation to the user. Accordingly, with the embodiment of FIG. 10, the device that executes the app serves as an interface device that intelligently bridges the external speakers with the external visual display to produce a coordinated AV presentation as described below. Together, the speakers, video streaming service, and external visual display can serve as the “player” for the visual and audio content with respect to the example of FIG. 10.

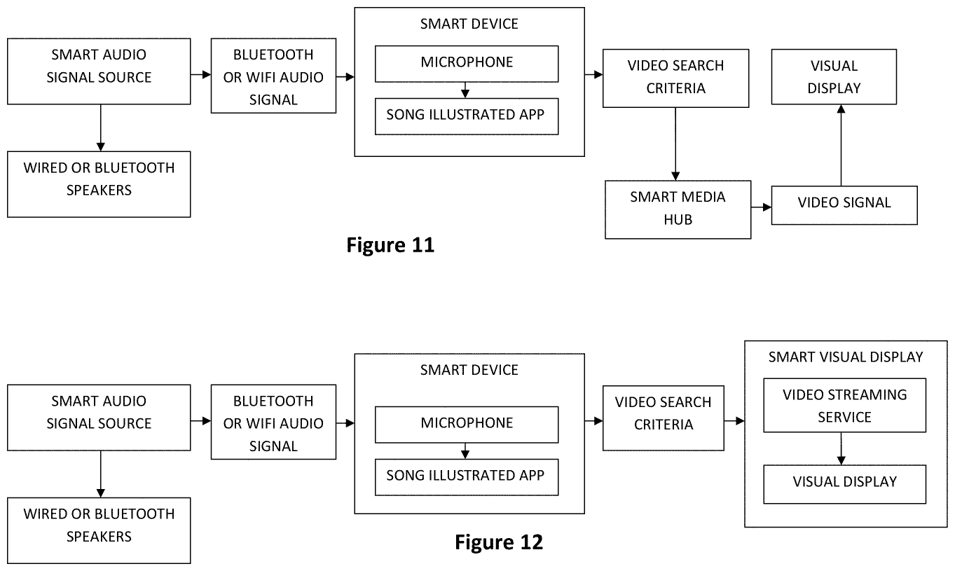

With the example of FIG. 11, the AV system takes the form of an external smart audio signal source and speakers in combination with a device such as a smart phone (or tablet computer, laptop computer, etc.), a smart media hub, and an external visual display (such as a computer monitor, smart TV, etc.). In the example of FIG. 11, the speakers (which may be wired or wireless (e.g., Bluetooth) speakers) play the song provided by the smart audio signal source. While the song is playing, the smart audio signal source also outputs an audio signal (e.g., a Bluetooth audio signal or a WiFi audio signal) that represents the song being played via the speakers. Similar to the FIG. 8 embodiment, an app executed by the device receives this audio signal and determines the song that is being played. Based on the song detection, the app can generate search criteria that would be used to identify the visual content to be paired with the song. The device can transmit these search criteria to the smart media hub. The smart media hub can be a hardware device that includes a processor, memory, and network interface (e.g., WiFi connectivity) as well as one or more video-capable output ports (e.g., HDMI out, USB out, etc.) so that it can access and provide a video signal to a video display. In this example, the smart media hub can serve as the video streaming service, and it can process the video search criteria to locate and retrieve the visual content for pairing with the song. The smart media hub can then communicate a video signal representative of the visual content to the external visual display, whereupon the external visual display renders the visual content for presentation to the user based on the video signal . Together, the speakers, smart media hub, and external visual display can serve as the “player” for the visual and audio content with respect to the example of FIG. 11.

With the example of FIG. 12, the AV system takes the form of an external smart audio signal source and speakers in combination with a device such as a smart phone (or tablet computer, laptop computer, etc.), and an external smart visual display (such as a smart TV, smart projector, etc.). In the example of FIG. 12, the system operates in a manner similar to that of FIG. 11, but where the video streaming service is resident in the smart visual display. Accordingly, the smart media hub can be omitted, and the video search criteria generated by the app can be transmitted to the smart visual display. The video streaming service can process the video search criteria to locate and retrieve the visual content for pairing with the song, whereupon the visual display renders the retrieved visual content for presentation to the user. Together, the speakers and external smart visual display can serve as the “player” for the visual and audio content with respect to the example of FIG. 12.

While FIGS. 5-12 show a number of different example embodiments for the AV system that can implement the inventive techniques described herein, it should be understood that still more alternate system topologies could be employed. For example, the smart visual display of the FIG. 12 embodiment could be employed with any of FIGS. 5-10 if desired. As another example, if the external visual display has its own set of speakers that can produce sound, it may be desirable to use such speakers as the pathway for playing the song rather than external speakers or speakers resident on a mobile device.

Returning to FIG. 1, the process flow for pairing visual content with audio content will now be described in greater detail.

Step 100: Obtain Audio Content Metadata

With reference to FIG. 1, at step 100, the application obtains metadata about an audio content item selected for playback to a user. The audio content item may take the form of an individual song (or tune or track) at a time, of any length. However, it should be understood that the audio content item could also be a group of multiple songs (a whole LP album, a playlist, an opera, etc.). The audio content metadata comprises descriptive information about the audio content item. As examples, the audio content metadata may include song title/name, artist, album (if applicable), song length, timecode for playback position, language (English, Spanish, etc.), etc. The metadata may also include additional information such as a song version (e.g., radio edit, live version, concert version, concert location, rem ix, extended remix, demo, etc.).

As examples, we propose two ways to identify the audio content item that is being played by the user. This audio content item can be shown as an audio signal source with reference to the accompanying drawings.

Technique #1—Obtain Content Metadata

The first technique for identifying the audio content item is well-suited for use with embodiments such as those shown by FIGS. 5, 6, 8, 9, 10, 11, and/or 12. With respect to the first technique, the app receives metadata information about the audio content item (which may include metadata fields such as those discussed above). This information can be passed directly via API from most media player apps (as well as over a broadband connection via “remote control” functionalities created for music apps such as Sonos or Spotify). This represents the most accurate and direct way to determine the content that is being consumed. In an example embodiment, our app can seek to use this method first and resort to Technique #2 when this data is not available.

Technique #2—Identify the Song via Waveform Recognition

The second technique for identifying the audio content item is well-suited for use with an embodiment such as that shown by FIG. 7 (although it should be understood that other embodiments such as any of those shown by FIGS. 10-12 could also employ the second technique). With respect to the second technique, the app may utilize device microphones or the device's internal audio driver to capture the waveforms being reproduced. These waveforms can then be compressed and sent to a database (which may be an external third party database or a database within the system) where the waveforms can be processed by an algorithm that determines the content and, with moderate accuracy, the time position of the content. The algorithm's determination of the content and time position of the content can then be sent to the Video/Visual matching to be described below. Example embodiments of this waveform matching/content recognition technology are currently available for license and may also be improved upon as may be desired by a practitioner for the use case described here to better recognize the time position of a content element. Examples of services that can be leveraged in this regard include Shazam, Soundhound, Gracenote, and the like.

In an example embodiment, either Technique #1 or Technique #2 could be employed by the system to perform step 100. However, it should be understood that the system may also employ both Techniques #1 and #2 if desired (e.g., primarily rely on Technique #1, but perform Technique #2 if content metadata is not readily available for the audio content item).

Step 102: Convert Audio Content Metadata into Search Query(ies)

At step 102, the application converts the audio content metadata into one or more search queries. In an example embodiment, this conversion can involve creating keywords for the search query from various fields of the audio content metadata. In a simple example embodiment, the search query can be a combination of keywords where the keywords match the artist metadata and the song title metadata (e.g., “Led Zeppelin”+“Fool in the Rain”). However, to increase the likelihood of turning of relevant search results, for other example embodiments, step 102 can involve generating multiple search queries from the audio content metadata, where the different search queries are derived from different fields of the audio content metadata. Some of the search queries may also include keywords that correspond to stock terms commonly used with songs, particularly videos for songs. For example, some stock terms that can be used to seek out concert or live video versions of songs may include terms such as “concert”, “live”, “hall”, “stadium”, “arena”, “acoustic” associated with “live” and/or “concert”, “one-night-only”, “festival”, “audience”, “on tour”, etc. Some of the search queries may include keywords derived from a database search for information known to be related to a given song (e.g., different albums in which the song was included, different artists who have performed the song, etc.). Accordingly, the different search queries can include combinations of keywords such as, where slots in the search query can be populated with data values corresponding to the data/field types identified below:
Search Query 1: Artist+Song Title (e.g., Led Zeppelin, Fool in the Rain)
Search Query 2: Artist+Song Title+Stock Term 1 (e.g., Led Zeppelin, Fool in the Rain in concert)
Search Query 3: Song Title+Stock Term 2 (e.g., Fool in the Rain, studio session)
Search Query 4: Artist+Stock Term 3+Song Title (e.g., Led Zeppelin live in concert, Fool in the Rain)
Search Query 5: Artist+Song Title+Album (e.g., Led Zeppelin, Fool in the Rain, In Through the Out Door)
Search Query 6: Artist+Song Title+Search-Derived Different Album (e.g., Led Zeppelin, Fool in the Rain, Greatest Hits)
Search Query 7: Artist+Song Title+Stock Term 4 (e.g., Led Zeppelin, Fool in the Rain cover)
Search Query 8: Artist+Stock Term 5 (e.g., Led Zeppelin Anthology)
Search Query 9: Artist+Stock Term 2 (e.g., Led Zeppelin studio session)
Search Query 10: Artist+Stock Term 6 (e.g., Led Zeppelin tour video footage)
Search Query 11: Artist+Stock Term 7 (e.g., Led Zeppelin making of)
Search Query 12: Artist+Song Title +Stock Term 8 (e.g., Led Zeppelin, Fool in the Rain, movie scene)
Search Query 13: Song Title+Stock Term 9 (e.g., Fool in the Rain lyrics)

It should be understood that these different search queries are examples only, and more, fewer, and/or different search queries may be generated at step 102 if desired by a practitioner. For example, additional search queries may specify release years if such information is present in the audio content metadata. Some additional stock terms that can be used for keywords in search queries may include “documentary”, “interview”, “photo”, “pictures”, “portfolio”, etc.

Step 104: Apply Search Query(ies) to Search Engine

At step 104, the application applies the search query (or search queries) generated at step 102 to a search engine. For a practitioner who is primarily interesting in pairing songs with videos, the search engine can be a searchable third party video content repository such as YouTube or other search engines where video content is readily available. However, other search engines could be used if desired by a practitioner, such as Google, Bing, etc. Furthermore, social media services such as Instagram, TikTok, Facebook, etc. may also serve as the search engines to which the search queries are applied. Further still, in some example embodiments, the app can be configured to apply one or more of the search queries to different or multiple search engines. For example, YouTube can be searched for video content, while Google could be searched for photographs or album cover art, while Instagram could be searched for visual “stories” that are linked to a given song, etc.

The search queries can be applied to the search engine by the application via an application programming interface (API). Through the API, the one or more search queries can be delivered to the search engine. A video streaming service (such as a YouTube app, Instagram app, etc.) that may be resident on a device in the AV system) can serve as the API, or the API can link the application with the video streaming service app.

In an example embodiment where multiple search queries are generated at step 102, these search queries can be delivered to the search engine as a batch to be more or less concurrently processed by the search engine. This is expected to significantly improve the latency of the system when a direct hit on a matching video for a song is not quickly identified by the search engine. As explained below with reference to steps 108 and 110, if such a direct hit is not found, the application can use search results from one or more of the additional search queries to identify suitable visual content for pairing with the audio content. By front-loading the search to include a search for all potential visual content pairing candidates, visual content can be selected and presented to users in less time than would likely be possible through an iterative approach where Search Query 2 is applied to the search engine only after it is determined that the search results from Search Query 1 did not produce a strong pairing candidate.

Step 106: Receive Search Results from Search Engine

At step 106, the application receives the search results from the search engine in response to the applied search query(ies). The application can receive these search results via an API connection with the search engine. The search results can be expressed in the form of metadata that describes each search result along with a link to the visual content corresponding to that search result. The search results metadata can include any of a number of data fields that provide descriptive information about the linked visual content. For example, the metadata can identify whether the linked visual content item is a video or a photograph. The metadata can also identify a title and artist for the visual content item. Additional metadata fields may include video length, location information for where the video was shot, release/publication date, bitrate, etc. The search results metadata may include many of the same types of metadata fields that the audio content metadata includes, particularly if the search result is highly on-point for the subject audio content. The search results metadata may also include data indicative of the popularity of the subject search result. For example, such popularity metadata can take the form of a count of times that the search result has been viewed or some other measure of popularity (e.g., a user score/rating for the search result).

Steps 108 and 110: Parse Search Results and Select Visual Content for Pairing

At step 108, the application parses the search results to support an analysis of which search results corresponding to suitable candidates for pairing with the audio content. At step 110, the application selects visual content for pairing with the audio content from among the search results based on defined criteria. In this fashion, step 110 may employ search engine optimization, machine learning technology, and/or user feedback to return a compelling visual content pairing or suggestion for pairing with respect to the subject audio content (for whatever audio content is being consumed).

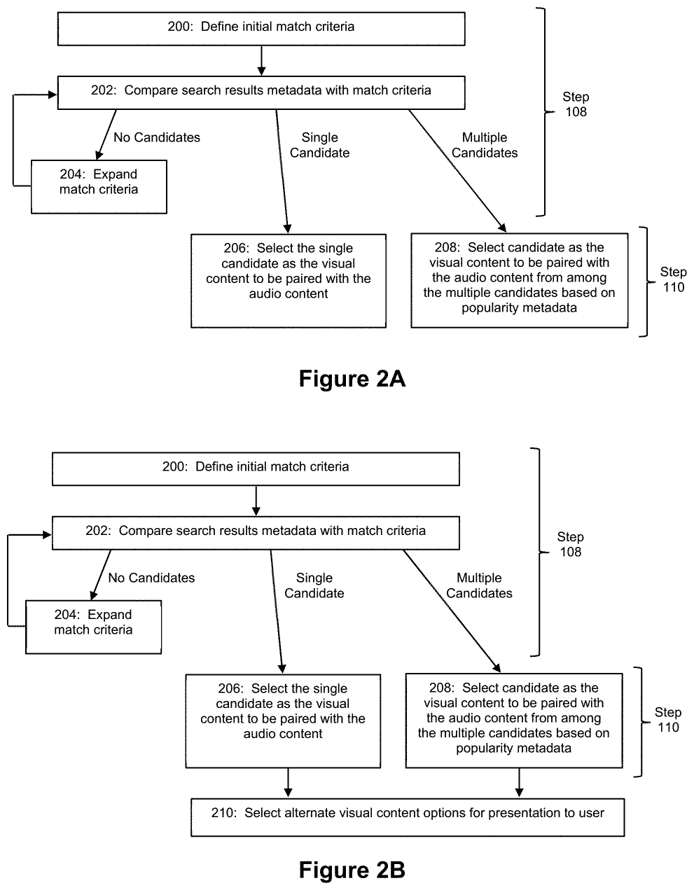

FIG. 2A shows an example process flow for steps 108 and 110. At step 200, initial match criteria are defined. These match criteria serve as the conditions to be tested to determine whether a search result represents a suitable candidate for pairing with the audio content. The initial match criteria can serve as a narrow filter that tightly searches for highly on-point visual content. For example, the initial match criteria can look for matches that require the search result to (1) be a video, (2) match between song name for the audio content and song name for the video search result, (3) match between artist for the audio content and artist for the video search result, (4) match between song length for the audio content and video length for the video search result, (5) match between album name for the audio content and album name for the video search result, and (6) a bitrate for the video search result that is at or above a defined minimum threshold.

At step 202, the application compares the search results metadata with the match criteria to determine if any of the search results are suitable candidates for pairing with the audio content.

If step 202 results in a determination that no suitable candidates exist within the search results based on the defined match criteria, the process flow proceeds to step 204. At step 204, the application expands the match criteria in order to loosen the filter. For example, the expanded criteria may no longer require a match between album names for the audio content and the video content. From step 204, the process flow returns to step 202 to look for candidate matches. Accordingly, it can be seen that steps 202 and 204 operate in concert to define a prioritized hierarchy of search results that satisfy one or more defined match conditions. Examples of potential hierarchies that can used for this process are discussed below. Also, while FIG. 2A (and FIG. 2B) show an example where steps 202 and 204 are performed in an iterative fashion, it should be understood that the application can perform steps 202 and 204 in a more or less single pass fashion where multiple hierarchies of match criteria are defined and applied to the search results to produce a score for each search result that is indicative of how relevant a given search result is to the subject audio content. As an example, a scoring mechanism may be employed where search results that are “hits” on narrow filters are given higher scores than search results that are only “hits” on looser filters. Such a scoring approach can lead to reduced latency for steps 108 and 110 in situations where the application is often falling back on the looser filters to find suitable pairing candidates.

If step 202 results in a determination that a single suitable candidate exists within the search results based on the defined match criteria, the process flow proceeds to step 206. At step 206, the application selects the single candidate for pairing with the audio content. The link to this selected search result can then be passed to a suitable player for the visual content (e.g., a video player).

If step 202 results in a determination that a multiple suitable candidates exist within the search results based on the defined match criteria, the process flow proceeds to step 208. At step 206, the application analyzes the popularity metadata associated with the multiple candidate search results to select the most popular of the candidate search results for pairing with the audio content. Thus, if Video 1 and Video 2 were both found to pass step 202, where Video 1 has a 500,000 views (or some other metric indicative of high popularity) while Video 2 has only 1,500 views (or some other metric indicative of relatively lower popularity), the application can select Video 1 for pairing with the audio content at step 208. It should be noted that popularity can be scored by the application in any of a number of ways. For example, the popularity analysis can also take into account a publication or posting date for a video in a manner that favors newer videos over older videos in some fashion (or vice versa). For example, a multi-factor popularity analysis can give more weight to newer videos than older videos. The link to the selected search result at step 208 can then be passed to a suitable player for the visual content (e.g., a video player).

FIG. 2B shows an example process flow for steps 108 and 110 where the application also presents the user with alternative options for pairing of visual content with the audio content. With FIG. 2B, at step 210, the application can select alternative visual content options from among the search results for presentation to a user. As an example, as part of step 210, the application can identify a set of search results that pass one or more of the criteria filters and/or score highly as being relevant to the audio content. For example, the 5 most relevant search results following the selected search result could be included in the set of alternative visual content options. As another example, the alternative visual content options can include search results corresponding to media types that are different than the type of visual content selected at step 110. Thus, if the selected visual content is a music video, the alternative options may include album cover art relevant to the song, a visual presentation of lyrics for the song (e.g., a karaoke lyrics display, which may include associated background imagery), and/or a photograph of the artist for the song. These alternate search results can then be presented as alternative options to a user via a user interface. Accordingly, if the user decides that the visual content selected at step 110 is not desirable, the user then has the option to switch over to the display of one of these alternative options by selecting a link or the like that is presented via a user interface.

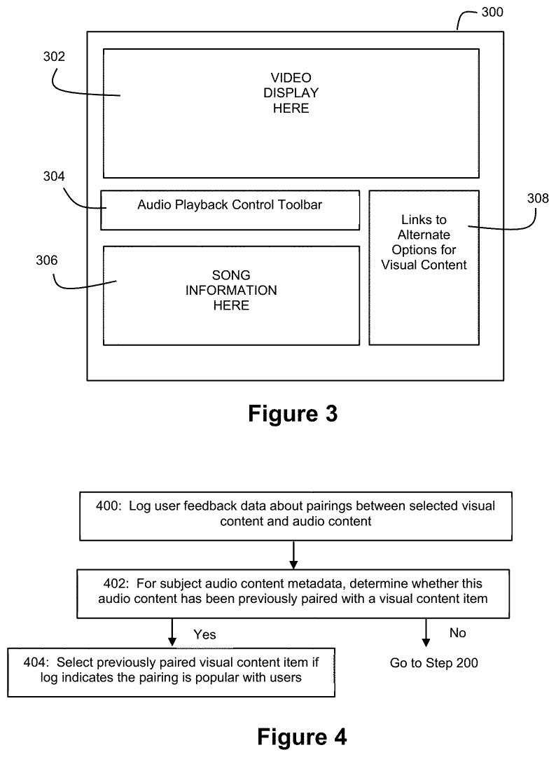

FIG. 3 shows an example user interface 300 that can be employed to present the user with alternative pairing options. User interface 300 can take the form of a graphical user interface (GUI) that is displayed on a screen such as a mobile device screen (e.g., a screen of a smart phone or tablet computer), television screen, or other suitable display screen. GUI 300 can include a screen portion 302 that serves to display the paired visual content (e.g., a music video paired by step 110 with the audio content). GUI 300 can include another screen portion 304 that serves to display a user-interactive audio playback control toolbar. Portion 304 can include controls such as play, pause, fast forward, rewind, volume up, volume down, timecode progress, repeat, etc. that are operative to control how the audio content is played on a relevant device (e.g., mobile device, speaker, turntable, etc.). GUI 300 can also include a portion 306 that presents information about the audio content being played. For example, portion 306 can include information such as song name, artist, album name, etc. GUI 300 can also include portion 308 where links to alternate options for paired visual content can be listed. The list may include thumbnails of such visual content as well as descriptive information derived from the search results metadata (e.g., a title, length, etc. for the visual content).

The FIG. 2A/2B process flows can also incorporate machine learning, and/or user feedback-based learning capabilities into the selection process for paired visual content. For example, the app could include a feature for collecting user feedback that is indicative of whether the user approves of the pairing that was made between visual content and audio content (e.g., a “thumbs up”, “heart”, or other indicator of approval can be input by the user via the app for logging by the system). The different items of visual content that have been paired with a given item of audio content across large pools of users can then processed using an artificial intelligence (AI) algorithm or the like to rank visual content items by popularity or the like to influence how those items of visual content will later be selected when that audio content is later played. The AI algorithm could then select the top ranked item of visual content for pairing with a given item of audio content or employ some other metric for selection (e.g., requiring that a visual content item has some threshold ranking level in order to be eligible for pairing). While this example describes the collection of “positive” user feedback to implement a learning capability, it should be understood that “negative” user feedback could be employed to similar ends as well. Moreover, the algorithm can also apply such learning across songs if desired by a practitioner. Thus, if Song A is deemed to be similar to Song B by the system on the basis of defined criteria (e.g., similar genre, similar melody, similar lyrics, a history of being liked by the same or similar users, a history of being played during the same listening session as each other, etc.), the algorithm could also apply learning preferences for Song A to Song B. Examples of such learned preferences could be a preference for a video over album cover art, a preference for concert video footage over other types of video footage, etc.).

As discussed below, video filters can be applied to the visual content to modify the manner by which the visual content is presented. The popularity and user feedback data can also be leveraged to learn which video filters are popular and the contexts in which various video filters are popular. This type of learning can then be used to improve curated content quality with respect to any video filters that are applied to the paired visual content when displayed to users.

FIG. 4 shows an example process flow where the application logs user feedback about pairings between selected visual content and audio content into a server (step 400). At step 400, the system can thus track information indicative of whether a given pairing between visual content and audio content was found accurate by users. In this regard, the log can record data such as how many times a given pairing between visual content and audio content was fully played through by users. Such data can represent a suitability metric for a given pairing between visual content and audio content. If the two were fully played through, this can be an indication that the pairing was a good fit. The log can also record data such as how many times a given pairing between visual content and audio content was paused or stopped by users during playback. This can be an indication that the pairing was not a best fit. In example embodiments where the application also performs step 210 as shown by FIG. 2B, the log can also record data such as how many times a given pairing between visual content and audio content was changed by users to a different item of visual content. This can not only indicate that the initial pairing was not a good fit, but it can also indicate that the changed pairing was a better fit. The user interface can also include a “like” button or the like that solicits direct user feedback about the pairing of visual content with audio content. User likes (or dislikes) can then indicate the quality of various pairings between visual content and audio content. The logs produced as a result of step 400 can then be used to influence the selection process at step 110.

For example, at step 402, the application can first check the log to see if a given audio content item has previously been paired with any visual content items. As usage of the system progresses with large numbers of users, it is expected that many songs will build large data sets with deep sample sizes that will show which items of visual content are best for pairing with those songs. If the logs show that one or more previously paired visual content items has a suitability score above some minimum threshold, then the application can select such previously paired visual content at step 404. If there are multiple suitable pairings in the log, the application can select the pairing that has the highest suitability score. If step 402 does not find any pairings (or step 404 does not find any pairing that is suitable), then the process flow can proceed to step 200 of FIGS. 2A/2B for deeper analysis of fresh search results. Accordingly, it should be understood that steps 402 and 404 can be embedded within step 110 to help support the selection of visual content items for pairing with audio content.

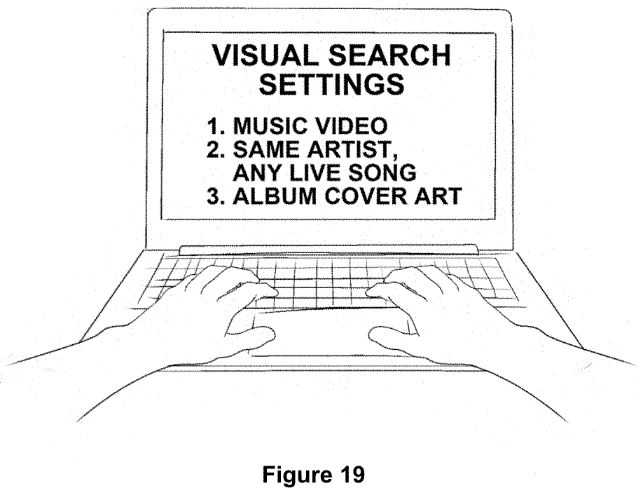

Returning to FIGS. 2A and 2B, as noted above, steps 200-204 can define a hierarchy of prioritized search results for potential pairing with an audio content item. As an example, this hierarchy can generally prioritize by types of visual content as follows: Video (highest priority)→Album Cover Art→Visualizations of Lyrics→Artist Photographs (lowest priority). However, it should be understood that alternative hierarchies can be employed, including more complicated, granular hierarchies (e.g., where album cover art may be favored over certain types of videos, etc.). Within the general hierarchy, filters can be employed as discussed above to score which search results are deemed more suitable than others. But, overall the hierarchy can operate so that steps 200-204 always eventually result in some form of visual content being paired with the audio content. FIG. 19 is a sketch depicting an example user interface through which a user can define a hierarchy to be used for visual content searches.

Step 112: Synchronize Visual Content with Audio Content

At step 112, the application synchronizes the playing of the selected visual content with the playing of the subject audio content. The synching of the content can be managed on a hierarchical basis dependent on the quality of information available. For example:

1st priority: Look at the video content and audio content metadata where available. This data can provide the exact position in the audio content which can be matched to the available video content with precision. A user interface can provide the user with the opportunity to correct the synchronization if the content is out of synch, which in turn can educate the algorithm for future matches of that content. For example, the video content can be displayed in conjunction with interactive user controls such as a video progress bar. The user would be able to adjust the video progress bar (e.g., tap and drag of a progress marker) to change how the video is synced with the audio. As another example, the video content can be displayed with a field for user entry of a time code that allows a user to jump the video content to defined time codes.

2nd priority: Determine synchronization via waveform matching algorithm. Current waveform matching databases (e.g., databases/services such as Shazam, Soundhound, Gracenote, and the like) can provide good estimates of the position within the content based on an analysis of the content's waveform. Our application can significantly improve the effectiveness of this time-identification by providing a buffered sound sample (going back 10 seconds, for example) to further aid the algorithm in determining the position within the content. Once the position is identified, the companion content can be synched via time-matching described above.

3rd priority: In areas where waveform matching is not able to yield a high-confidence result, a practitioner may choose to design the app to perform a more advanced version of “beat-matching,” where the waveform is analyzed to determine the ‘beat’ of the music content, and the companion content will be scanned and aligned to the same beat during playback. Beat-matching software/firmware can perform an analysis on waveforms for the song and the audio portion of video content to determine the period of the beats and the time locations of the beats for the song and video content. The software/firmware can then find a position in the video content where alignment is found between the beats of the audio content and video content. This innovative application of beat analysis technology can be done locally on our app/device, without an external call to a server, because the algorithms for such beat analysis/matching can be relatively light and performed using relatively few processing cycles on a digital device (or even integrated into an analog or integrated circuit included with the device as a hardware adapter). However, in other example embodiments, a practitioner may choose to offload the beat analysis/matching operations to server connected to the device via a network.

4^{th} priority: Where no synching recommendation is available, the user can be presented with a simple, graphical method in the user interface to ‘drag’ the companion content to sync with the beat of the audio content. As mentioned above, this user engagement can be captured and used to improve matching for future searches.

### 2. User Experience and Example Features

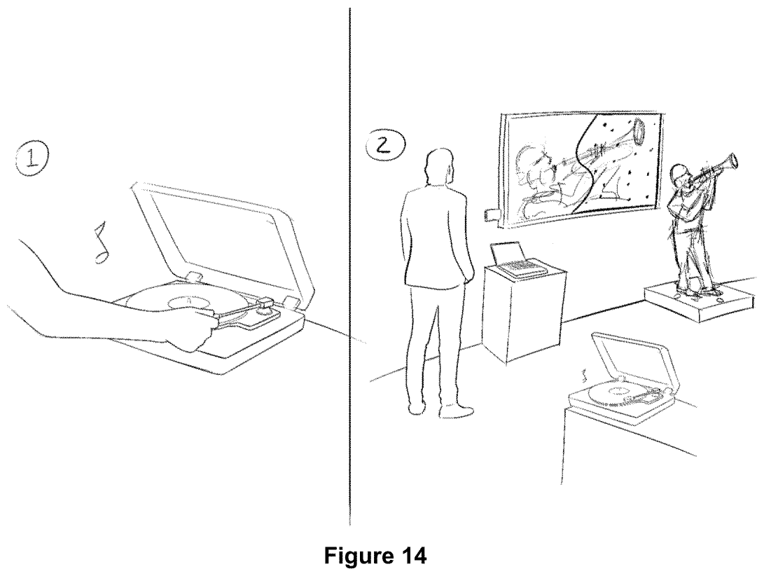

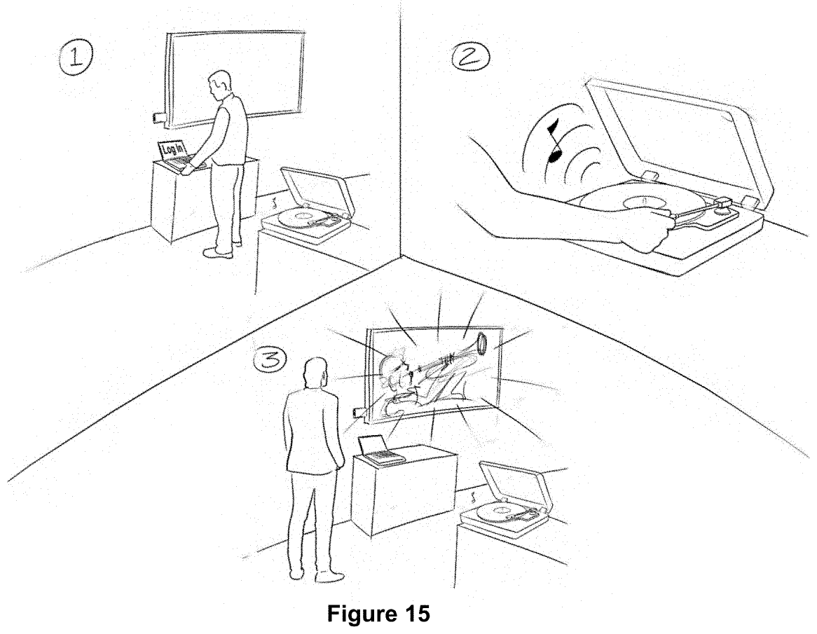

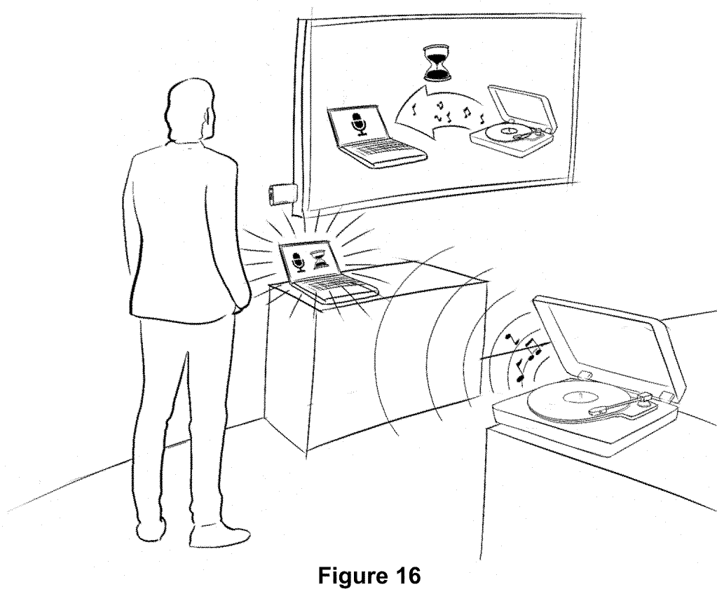

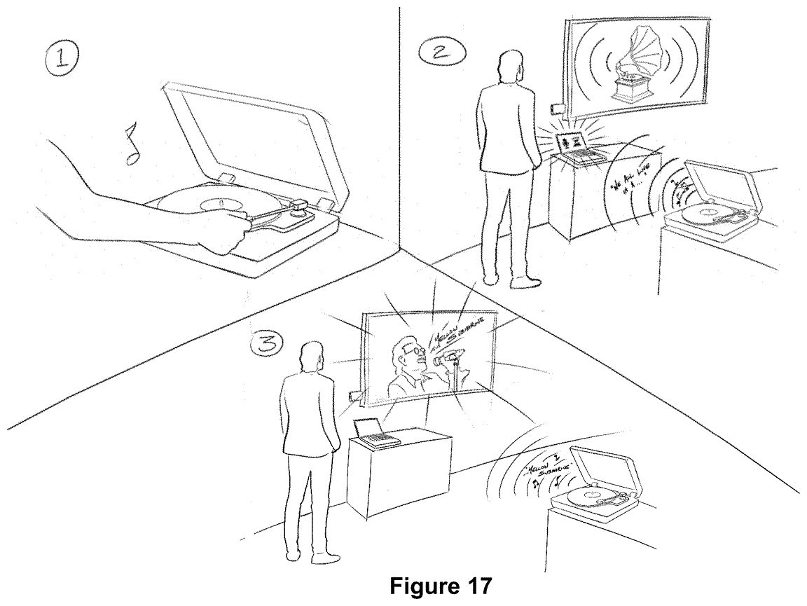

FIGS. 14-18 are sketches that depict an example user experience with an embodiment as disclosed herein:
A Prince fan is having friends over to share the favorite songs they have on vinyl
The user starts by turning on their TV, music system and matching service adapter (Song Illustrated). A log in process may be employed if the user needs to log in to an account for accessing the service—see FIG. 15). Furthermore, as the various system components connect and/or pair with each other, a The Prince fan sets the Purple Rain vinyl on a turntable (e.g., see Frame 1 in FIG. 14).
The song starts when the needle lands on the groove. Purple Rain begins playing and within a very low latency period, the Smart TV automatically displays placeholder content while the additional content is identified and prepared for visual presentation. As an example, such placeholder content can be a video of a vintage gramophone playing a record (played for a few seconds—e.g., see Frame 2 of FIG. 17).
Within a few seconds, the music video for Purple Rain is linked, served, and synchronized to play in full screen—e.g., see Frame 3 of FIG. 17.
After the song has played, the needle lifts from the record's groove
Simultaneously, the TV screen displays placeholder content such as a close-up video of a needle lifting up and a record being removed from the same gramophone. The user places a vinyl of a Prince live concert that starts with the song “Kiss”
At the very same time, the Smart TV automatically displays placeholder content such as a video of the LOVE turntable playing a record for a few seconds
Within a few seconds, the music video of the same live version of “Kiss” is playing in full screen (see Frame 2 in FIG. 14).
The user places the vinyl Side B of the Sign o' the Times LP and places the needle on the second track and “Starfish and Coffee” (a song that doesn't have any official music video) starts to play. At the very same time, the Smart TV automatically displays a video of an 8-second long silent advertising for the LOVE turntable playback solution (or other advertisement).
Within a few seconds, the still album cover art of Sign o' the Times is playing in full screen or lyrics, or song trivia can be presented.
There is nothing extra that needs to be done on the user end
When the user is done playing records, the TV stops playing any video signal after 20-seconds and the TV automatically goes to Standby mode.

This example applies similarly to a song being played by any type of medium or devices playing music including listening to the radio, streaming, CD player, etc., while being matched and played on other video streaming platforms, hologram databases, DJ lightings, etc.

With an example embodiment, the user only hears the audio they are already listening to. The companion content does not provide any accompanying extra sound (except for optional sounds filters if desired). Furthermore, user interaction with the audio playback can automatically carry over into the playback of the video content. Thus, if a user pauses the song on his or her device, this can automatically trigger a pause in the playing of the video content. Similarly, when a user re-starts the song, this can also automatically trigger the video to start playing again. As another example, a user fast-forwarding or rewinding the song can automatically trigger a concomitant fast-forward or rewind of the video content. This can be achieved by the app generating control commands for the video streaming service in response to user inputs affecting the audio playback.

In additional example embodiments, the matching service (Song Illustrated, Music Genie, Music Seen) may also offer a user options such as any combination of the following:
Setting video filters: e.g., ‘visual cracks and pops or scratches’ that are added to a music video playing at the same time as a vinyl version of the song that is being played, or ‘80′s video bleeding effects’, or a combination of both or more. The Raconteur “Help me stranger” music video shows a repeated image in the beginning that illustrates vinyl scratches, visually.
Playing a video hologram that matches the song being played, in place of or in addition to the video. E.g., a life-size Elvis Presley video hologram ‘spontaneously’ popping up in sync as one of his songs plays, or a life-size video hologram of the conductor, Gustavo Dudamel, who jumps during his performances while his concerto/orchestra plays alongside in the background. For such an embodiment, a hologram projector can serve as part of the player for the AV system. Such a hologram projector can take the form of a smart hologram projector that has network connectivity (e.g. WiFi-capable).
Using the algorithm to provide information to optimize advertising that is a suitable match to the content and/or consumer, where the advertising can be combined with other content or be served to the user as content.

### 3. Example Login Process

FIG. 15 is a sketch that depicts an example login process for embodiments as described herein.

3.1 One one-time way is to login directly through any of the video streaming platforms (e.g., YouTube app on a smart TV, an Apple TV, a Chromecast, a game console, etc.)

3.2 Another one-time way is for the user to connect to the matching service device website that serves as an interface for connecting, searching, and the user starts playing each song automatically—over a browser (see, e.g., Frame 1 in FIG. 15).

3.3 Smart Hardware Adapter

The smart adapter can be a simple internet connected over Wi-Fi device with a microphone. It can offer more sophisticated features such as: a pass-through audio line-in to be connected to a music playing device so that an external microphone isn't necessary and the capture of the played music is more accurate; a video line-out so that it serves as an all-in-one video player and allows to offer extra layers of video visual effects or skins; a built-in hologram player that can offer the same improvement the video line-out, etc.

### 4. Example Visuals for Use During Buffering Time

Many types of visuals can be displayed while the song name and artist are being identified such as:
A video illustration of the user-predefined similar medium/service/device playing the music—e.g. A turntable, cassette, 8-track, CD player, a Spotify, Apple Music, Deezer clip, etc.
An advertisement that is selected and targeted to the user based on user demographics and/or the audio content being played.

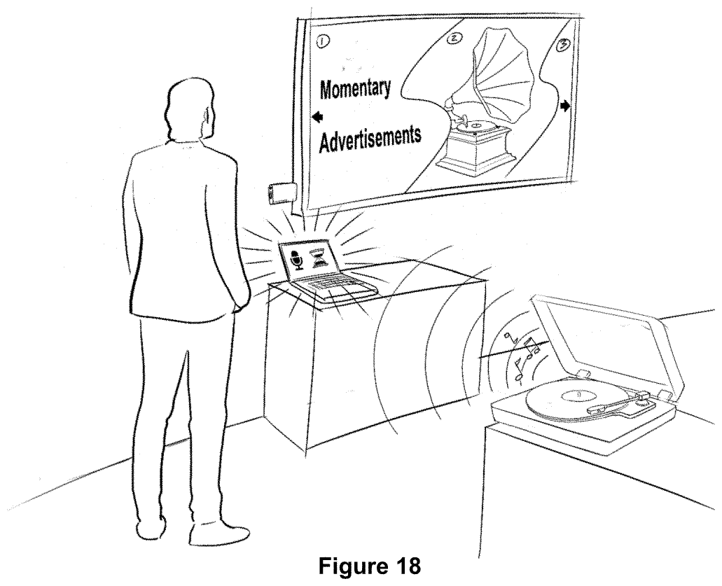

A business model can be made of the following, but not exclusively:
A monthly subscription
A free ad-based model where the user sees a silent advertising during the 5-10 seconds it takes for the song to be identified and played on YouTube (e.g., see FIG. 18)
An advertisement-supported model that utilizes algorithms to target and pair users with appropriate advertising content
Through a Vevo-like business model
Ability to link to lyrics, ticket sales/merchandise/concerts, etc.

### 5. Other Example Features and Hardware

Software (LOVESTREAM)

A practitioner may also offer a streaming service that will allow the turntable user to share their live and/or recorded vinyl record playing with other users within the community. This combined with the database of the owner's record collection which is automatically created by the companion App, allows enthusiasts to search other users' collections or discover mutual interests. It can be a monthly subscription model where a live vinyl record song and/or playlist shared with friends or other community members that can then benefit from a large or rare collection of records or a specific knowledge they could not listen to otherwise.

Hardware—Ultra Portable 3″ Record Turntable

One way is to have the turntable offer most similar embodiments as a portable CD player, replacing the laser by a needle.

While the invention has been described above in relation to its example embodiments, various modifications may be made thereto that still fall within the invention's scope. Such modifications to the invention will be recognizable upon review of the teachings herein.

What is claimed is:

1. A computer program product for interacting with an audio/visual (AV) system, the computer program product comprising:
a plurality of instructions that are resident on a non-transitory computer-readable storage medium, wherein the instructions are arranged for execution by a processor to cause the processor to:
identify an item of audio content;
determine an item of additional content based on the identified audio content item; and
interact with a player to produce a visual presentation of the determined additional content item for display to a user in conjunction with an audio presentation of the identified audio content item.

2. The computer program product of claim 1 wherein the instructions that determine the additional content item comprise a plurality of instructions for execution by the processor to cause the processor to:
process data representative of the identified audio content item to generate a search query for a content database;
apply the generated search query to the content database;
receive a search result in response to the applying step, wherein the search result identifies the additional content item; and
obtain the additional content item based on the search result.

3. The computer program product of claim 2 wherein the instructions that receive the search result comprise a plurality of instructions for execution by the processor to cause the processor to receive a set of search results in response to the applied search query;
wherein the instructions that determine the additional content item comprise a plurality of instructions for execution by the processor to cause the processor to select a search result from the set based on a plurality of defined criteria; and
wherein the instructions that obtain the additional content item comprise a plurality of instructions for execution by the processor to cause the processor to select the additional content item based on the selected search result.

4. The computer program product of claim 3 wherein the instructions that determine the additional content item comprise a plurality of instructions for execution by the processor to cause the processor to apply a hierarchy of criteria filters to the search results to assess which search result is to be selected for pairing with the audio content item.

5. The computer program product of claim 2 wherein the instructions that process data representative of the identified audio content item comprise a plurality of instructions for execution by the processor to cause the processor to convert metadata for the audio content item into a plurality of search queries; and
wherein the instructions that apply the generated search query comprise a plurality of instructions for execution by the processor to cause the processor to apply the generated search queries to the content database.

6. The computer program product of claim 5 wherein the instructions that apply the generated search queries comprise a plurality of instructions for execution by the processor to cause the processor to apply the generated search queries to the content database by delivering the search queries as a batch to a search engine for the content database.

7. The computer program product of claim 1 wherein the instructions further comprise a plurality of instructions for execution by the processor to cause the processor to log user feedback data about previous pairings between audio content items and additional content items; and
wherein the instructions that determine the additional content item comprise a plurality of instructions for execution by the processor to cause the processor to employ a learning model for selecting additional content items based on the logged user feedback data.

8. The computer program product of claim 1 wherein the instructions that identify the audio content item comprise a plurality of instructions for execution by the processor to cause the processor to read metadata that is associated with the audio content item.

9. The computer program product of claim 1 wherein the instructions that identify the audio content item comprise a plurality of instructions for execution by the processor to cause the processor to:
analyze a waveform representation of at least a portion of the audio content item to generate a signature for the audio content item;
apply the generated signature to the an audio content signature database; and
identify the audio content item based on a response from the audio content signature database to the applied signature.

10. The computer program product of claim 1 wherein the instructions further comprise a plurality of instructions for execution by the processor to cause the processor to synchronize the visual presentation of the additional content item with the audio presentation of the audio content item.

11. The computer program product of claim 10 wherein the instructions that synchronize the visual presentation with the audio presentation comprise a plurality of instructions for execution by the processor to cause the processor to:
identify a time position for the audio content item; and
synchronize the visual presentation of the additional content item with the audio presentation of the audio content item based on the identified time position.

12. The computer program product of claim 10 wherein the instructions that synchronize the visual presentation with the audio presentation comprise a plurality of instructions for execution by the processor to cause the processor to:
analyze a waveform representation of a portion of the audio content item to generate a signature for the audio content item;
apply the generated signature to the an audio content signature database;
identify a time position within the audio content item for the audio content item portion corresponding to the waveform representation based on a response from the audio content signature database to the applied signature; and
synchronize the visual presentation of the additional content item with the audio presentation of the audio content item based on a matching of the identified time position.

13. The computer program product of claim 10 wherein the instructions that synchronize the visual presentation with the audio presentation comprise a plurality of instructions for execution by the processor to cause the processor to:
perform a beat extraction on at least a portion of the audio content item to generate a beat signature for the audio content item;
perform a beat extraction on at least a portion of the additional content item to generate a beat signature for the additional content item; and
synchronize the visual presentation of the additional content item with the audio presentation of the audio content item based on a matching of the beat signatures for the audio content item and the additional content item.

14. The computer program product of claim 10 wherein the instructions that synchronize the visual presentation with the audio presentation comprise a plurality of instructions for execution by the processor to cause the processor to synchronize the visual presentation of the additional content item with the audio presentation of the audio content item based on user input.

15. The computer program product of claim 1 wherein the audio content item comprises a song; and
wherein the additional content item comprises at least one of a video, an image, album cover art for an album that includes the audio content item, an image of an artist for the audio content item, textual lyrics for the audio content item, a hologram, and/or an advertisement.

16. The computer program product of claim 1 wherein the instructions that interact with the player comprise a plurality of instructions for execution by the processor to cause the processor to control the player to produce the visual presentation without interrupting the audio presentation of the audio content item.

17. The computer program product of claim 16 wherein the instructions that interact with the player comprise a plurality of instructions for execution by the processor to cause the processor to control the player to block any playback of an audio component of the additional content item during the visual presentation of the additional content item and the audio presentation of the audio content item.

18. An audio/visual (AV) system comprising:
a processor for use with the AV system, the processor configured to (1) identify an item of audio content and (2) determine an item of additional content based on the identified audio content item; and
a player for use with the AV system, the player configured to visually present the determined additional content item for display to a user in conjunction with an audio presentation of the identified audio content item.

19. The AV system of claim 18 wherein the processor comprises a plurality of processors.

20. The AV system of claim 18 wherein the processor and/or the player are part of at least one of (1) smart phone, (2) a tablet computer, (3) a laptop computer, (4) a smart speaker, (5) a record turntable, (6) a smart media hub, (7) a smart TV, and/or (8) smart projector.

21. A method comprising:
a processor identifying an item of audio content;
a processor determining an item of additional content based on the identified audio content item; and
a player visually presenting the determined additional content item for display to a user in conjunction with an audio presentation of the identified audio content item.
